(19) United States
(12) Patent Application Publication
(10) Pub. No.: US 2025/0236144 A1
(43) Pub. Date: Jul. 24, 2025

(54) TOWING HITCH SYSTEMS

(71) Applicant: Projects Designed and Built, Inc., Toledo, OH (US)

(72) Inventor: Jack W. Martin, Sylvania, OH (US)

(21) Appl. No.: 18/989,866

(22) Filed: Dec. 20, 2024

Related U.S. Application Data
(60) Provisional application No. 63/622,840, filed on Jan. 19, 2024.

(51) Int. Cl. B60D 1/30; B60D 1/00; B60D 1/36

(52) U.S. Cl. CPC B60D 1/30; B60D 1/36; B60D 2001/006

(57) ABSTRACT

A towing hitch system configured to connect a cart trolley with a material cart is provided. The towing hitch system includes a trolley hitch connected to the cart trolley. The trolley hitch has a first connection interface. A cart hitch is connected to the material cart. The cart hitch has a second connection interface. The second connection interface has a cavity configured to receive a portion of the first connection interface. The combination of the first connection interface and the second connection interface is configured to form a semi-rigid connection therebetween. The semi-rigid connection is configured to prevent front-to-back movement and side-to-side movement of the material cart relative to the cart trolley. The semi-rigid connection is further configured to limit vertical rotation of the material cart relative to the cart trolley.

### CROSS REFERENCE TO RELATED APPLICATIONS

This application claims the benefit of pending U.S. Provisional Patent Application No. 63/622,840, filed on Jan. 19, 2024. The entire disclosure of this application is incorporated herein by reference in its entirety.

### FIELD

The present disclosure relates generally to hitch systems used for towing material carts and, more particularly, to hitch systems used for towing material carts carrying long loads, heavy loads and/or loads over uneven or sloped ground.

### INTRODUCTION

The statements in this section merely provide background information related to the present disclosure and may not constitute prior art.

Material carts are configured to carry materials and can be towed behind a motorized cart trolley. A material cart can be connected to the motorized cart trolley with a towing hitch system. In certain instances, the towing hitch system includes a trailer ball positioned on the motorized cart trolley and a coupler connected to and extending from the material cart. As is known in the art, the trailer ball is received within the coupler in a manner that facilitates rotation of both the material cart and the motorized cart trolley about the trailer ball. Rotation of the material cart and the motorized cart trolley occurs when the steering wheels of the motorized cart trolley are turned. The combination of the motorized cart trolley and the material cart can form a substantially arcuate shape.

In certain instances, the materials carried by the material cart can be long and/or heavy. In the event the carried materials are longer than the length of the material cart, the carried materials can extend beyond the front and/or rear of the materials cart. In the event the carried materials extend beyond a front edge of the material cart, the forward end of the carried materials can potentially contact the motorized cart trolley in a manner such as to interfere with the turning of the motorized cart trolley. It is also known that long loads and/or heavy loads can interfere with the turning of the motorized cart trolley.

In certain instances, the ground traveled by the motorized trolley cart and the material cart can be uneven and/or sloped. In these instances, it is known that the uneven ground or sloped ground can interfere with the turning of the motorized cart trolley.

Accordingly, it would be advantageous if a motorized cart trolley were coupled to a material cart in a manner to facilitate turning when long loads and/or heavy loads are carried by the material cart and when the motorized cart trolley and the material cart travel over uneven or sloped ground.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the bicycle hub and spoke arrangement.

The above objects as well as other objects not specifically enumerated are achieved by a towing hitch system configured to connect a cart trolley with a material cart. The towing hitch system includes a trolley hitch connected to the cart trolley. The trolley hitch has a first connection interface. A cart hitch is connected to the material cart. The cart hitch has a second connection interface. The second connection interface has a cavity configured to receive a portion of the first connection interface. The combination of the first connection interface and the second connection interface is configured to form a semi-rigid connection therebetween. The semi-rigid connection is configured to prevent front-to-back movement and side-to-side movement of the material cart relative to the cart trolley. The semi-rigid connection is further configured to limit vertical rotation of the material cart relative to the cart trolley.

The above objects as well as other objects not specifically enumerated are also achieved by a cart trolley in combination with and connected to a material cart. The combination of the trolley cart and the material cart include a trolley hitch connected to the cart trolley. The trolley hitch has a first connection interface. A cart hitch is connected to the material cart. The cart hitch has a second connection interface. The second connection interface has a cavity configured to receive a portion of the first connection interface. The combination of the first connection interface and the second connection interface is configured to form a semi-rigid connection therebetween. The semi-rigid connection is configured to prevent front-to-back movement and side-to-side movement of the material cart relative to the cart trolley. The semi-rigid connection is further configured to limit vertical rotation of the material cart relative to the cart trolley.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a left-side perspective view of a cart trolley and a material cart fitted with a first embodiment of a towing hitch system, in accordance with the invention.

FIG. 2 is a left-side view of the cart trolley, material cart and first embodiment of the towing hitch system of FIG. 1.

FIG. 3 is an exploded left side perspective view of the cart trolley, material cart and first embodiment of the towing hitch system of FIG. 1.

FIG. 4 is a left-side exploded perspective view the cart hitch of FIG. 4 and the trolley hitch of FIG. 4.

FIG. 5 is a left-side view of the material cart of FIG. 3 fitted with the cart hitch of FIG. 4 and engaged with the trolley hitch of FIG. 4.

FIG. 6 is a left-side view of the cart hitch of FIG. 4 and the trolley hitch of FIG. 4 illustrating vertical rotation of the trolley hitch.

FIG. 7 is a plan view of the cart trolley, material cart and the first embodiment of the towing hitch system of FIG. 1, shown in a first turning orientation.

FIG. 8 is a plan view of the cart trolley, material cart and the first embodiment of the towing hitch system of FIG. 1, shown in a second turning orientation.

FIG. 9 is a right-side perspective view of a second embodiment of a towing hitch system.

FIG. 10 is a rear view of the second embodiment of the towing hitch system of FIG. 9.

FIG. 11 is a left-side view of the second embodiment of the towing hitch system of FIG. 9.

FIG. 12 is a left-side view of a portion of the cart trolley of FIG. 9 and a portion of the material cart of FIG. 9 illustrating an initial operational step.

FIG. 13 is a left-side view of a portion of the cart trolley of FIG. 9 and a portion of the material cart of FIG. 9 illustrating a final operational step.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers, and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIGS. is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In accordance with embodiments of the present invention, a towing hitch system for a material cart carrying long and/or heavy loads is provided. Generally, the towing hitch system includes a trolley hitch connected to a cart trolley and a cart hitch connected to a material cart. In certain embodiments, the trolley hitch and the cart hitch are connected together in a manner such that a semi-rigid connection between the cart trolley and the materials cart is formed. The semi-rigid connection means front-to-back movement and a side-to-side movement of the material cart relative to the cart trolley is substantially prevented, however limited vertical rotation of the material cart relative to the cart trolley is possible. The semi-rigid connection provides an operator with unexpectedly precise handling of the combined cart trolley and the material cart, when long and/or heavy loads are carried by the material cart.

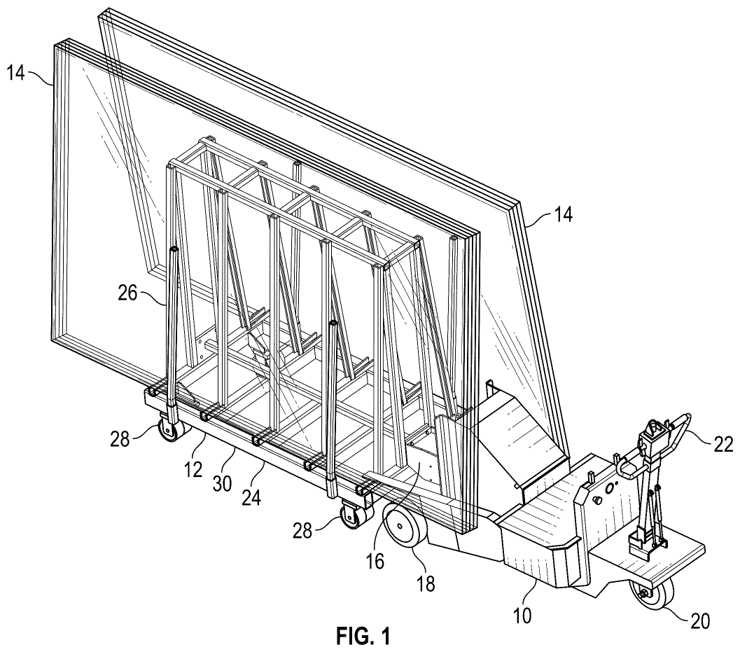

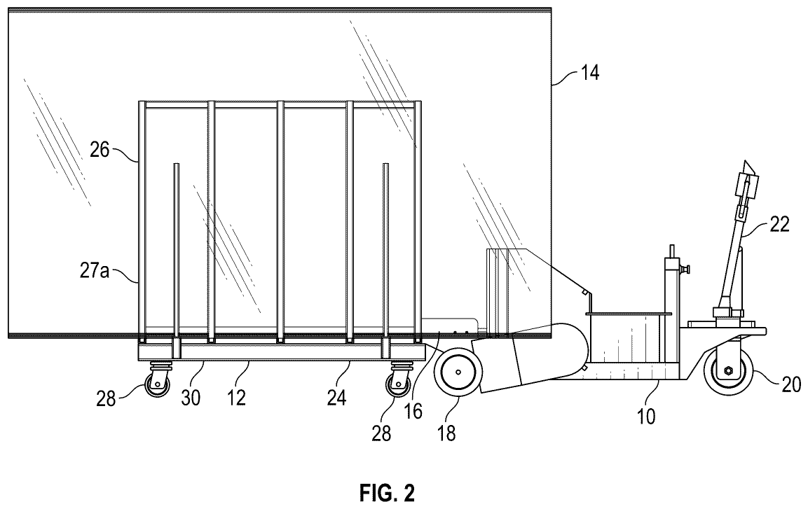

Referring now to FIGS. 1 and 2, a cart trolley 10 is shown coupled to a material cart 12. The material cart 12 is loaded with a supply of materials 14. In the illustrated embodiment, the materials 14 have the form of sheet materials, such as the non-limiting example of glass panels. However, in other embodiments, the materials 14 can have other forms, including the non-limiting examples of stone slabs, drywall panels and the like.

Referring again to FIGS. 1 and 2, the cart trolley 10 is configured for self-propelled movement and is further configured to move the material cart 12 and the materials 14 contained in/on the material cart 12 as the cart trolley 10 moves. The cart trolley 10 and the material cart 12 are coupled together through use a towing hitch system 16. The towing hitch system 16 will be discussed in more detail below.

Referring again to the embodiment illustrated in FIGS. 1 and 2, the cart trolley 10 has the form of a self-propelled vehicle, known in the art as a “tugger”. It should be appreciated that in other embodiments, the cart trolley 10 can have other forms. Non-limiting examples of other suitable towing vehicles include forklift trucks, dollies, towing trolleys, towing tractors, and the like.

Referring again to FIGS. 1 and 2, the cart trolley 10 includes a plurality of ground engaging rear wheels 18 and a plurality of ground engaging, steerable front wheels 20. In the illustrated embodiment, a lone ground engaging, steerable front wheel 20 is used. However, in alternate embodiments, more than one ground engaging front wheel 20 can be used. In the illustrated embodiment, the rear and front wheels 18, 20 have the form of pneumatic tires fitted to metallic hubs as is known in the towing art. It should be appreciated that in other embodiments, the rear and front wheels 18, 20 can have other forms including the non-limited example of solid polyurethane tires, each fitted to a cylindrical, metallic hub.

Referring again to FIGS. 1 and 2, the cart trolley 10 is configured to be self-powered by conventional methods, including the non-limiting examples of rechargeable batteries, propane-based power sources and the like.

Referring again to FIGS. 1 and 2, the plurality of ground engaging, steerable front wheels 20 are controlled by a steering mechanism 22. The steering mechanism 22 can have various forms as in known in the towing arts, including the non-limiting examples of a steering wheel, a tiller, and the like. It should be appreciated that in other embodiments, the plurality of ground engaging, steering front wheels 20 can be controlled by other structures, mechanisms, and devices.

Referring again to FIGS. 1 and 2, the materials cart 12 includes a base framework 24 configured to support an upper framework 26. The base framework 24 and the upper framework are each formed with structural members, sufficient to support the materials 14. One non-limiting example of a sufficient structural member is steel tubing. However, in other embodiments, other materials and forms can be used, sufficient to support the materials 14.

In the embodiment illustrated in FIGS. 1 and 2, the base framework 24 and the upper framework 26 cooperate to form an A-frame type of structure. The A-frame structure is configured to facilitate positioning of the materials 14 against the upper framework 26 at an angle. Without being held to the theory, it is believed positioning of the materials 14 at an angle provides for safe movement and storage of the materials 14. In alternate embodiments, the base and upper frameworks 24, 26 can cooperate to form other shapes and structures configured to receive the materials 14 for safe movement and storage.

Referring now to FIGS. 1-3, a plurality of omni-directional, ground engaging casters 28 extend from a lower portion 30 of the base framework 24. The omni-directional casters 28 are configured to engage a ground surface (not shown) and support the weight of the material cart 12 and the materials 14 contained on the material cart 12. The plurality of omni-directional, ground engaging casters 28 are further configured to facilitate movement of the material cart 12 in any direction as actuated by the cart trolley 10. In the illustrated embodiment, the plurality of omni-directional casters 28 have the form of heavy duty polymeric-based rollers, as is known in the towing arts. However, in other embodiments, the plurality of omni-directional casters 28 can have other forms sufficient for the functions described herein.

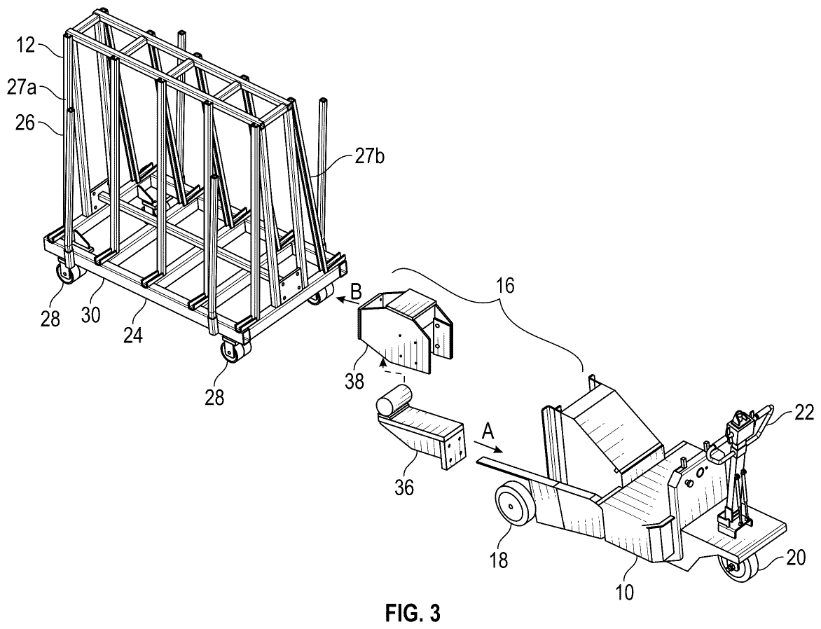

Referring now to FIG. 3, the cart trolley 10, material cart 12 and a first embodiment of the towing hitch system 16 are shown in an exploded view. The towing hitch system 16 includes a trolley hitch 36 and a mating cart hitch 38. The trolley hitch 36 is fixedly connected to a rear portion of the cart trolley 10, as schematically depicted by direction arrow A. The mating cart hitch 38 is fixedly connected to an end portion of the material cart 12, as schematically depicted by direction arrow B. As will be explained in more detail below, a portion of the trolley hitch 36 is received within a portion of the mating car hitch 38, thereby forming a semi-rigid connection.

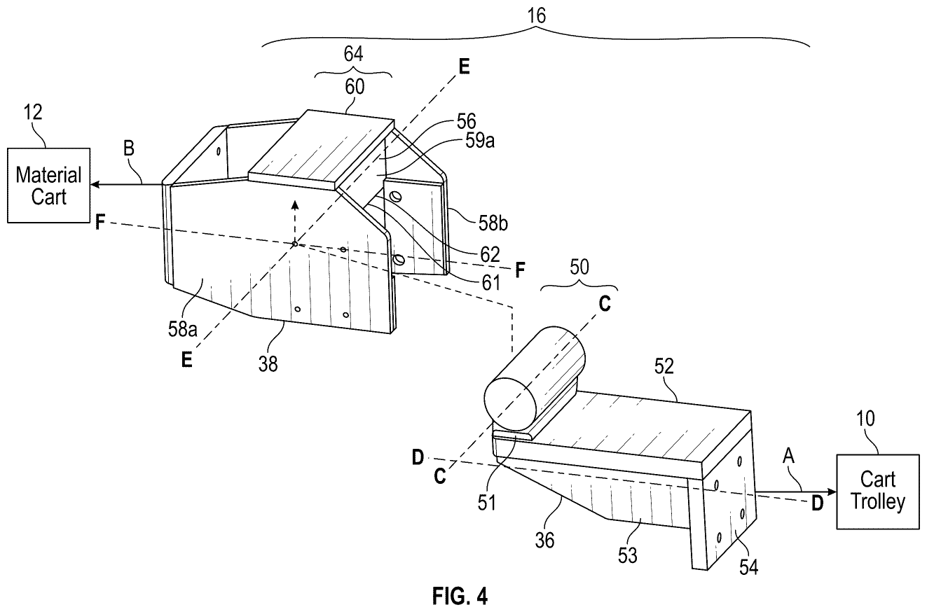

Referring now to FIG. 4, the trolley hitch 36 and the mating cart hitch 38 are shown spaced apart from each other. The trolley hitch 36 is fixedly connected to a rear portion of the cart trolley 10, as schematically depicted by direction arrow A. The mating cart hitch 38 is fixedly connected to an end of the material cart 12, as schematically depicted by direction arrow B. The trolley hitch 36 includes a first connection interface 50 connected to a spacing member 51. In the illustrated embodiment, the first connection interface 50 has the form of a horizontally oriented cylinder. However, in other embodiments, the first connection interface 50 can have other suitable forms. The spacing member 51 is configured for connection to a trolley hitch base 52 and is further configured to space the first connection interface 50 a desired distance from the trolley hitch base 52. The spacing member 51 is configured to facilitate limited rotation of the trolley hitch.

Referring again to FIG. 4, optionally, the trolley hitch 36 can include a support 53 connected to the trolley hitch base 52 and a trolley connector member 54. The support 53 is configured for structural support of the trolley hitch 36 and has the form of a metallic plate material. It should be appreciated that the support 53 can have other forms and can be made from other materials sufficient to provide structural support of the trolley hitch 36. It should also be appreciated that the support 53 is optional and is not required for successful operation of the towing hitch system 16.

Referring again to FIG. 4, the first connection interface 50 has a longitudinal axis C-C. In the illustrated embodiment, the longitudinal axis C-C of the first connection interface 50 is substantially perpendicular to a longitudinal axis D-D of the trolley hitch 36. Without being held to the theory, it is believed the perpendicular orientation of the longitudinal axes C-C and D-D facilitates the effectiveness of the semi-rigid connection between the trolley hitch 36 and the cart hitch 38. However, in other embodiments, the first connection interface 50 and the trolley hitch 36 can have other relative orientations, sufficient to form a semi-rigid connection therebetween.

Referring again to FIG. 4, the mating cart hitch 38 includes a multi-side housing 56 formed by opposing cart hitch end plates 58a, 58b, opposing side members 59a, 59b (side member 59b is not shown for purposes of clarity) and a top member 60. The multi-sided housing 56 forms an opening 61 opposite the top member 60. The multi-sided housing 56 forms a cavity 62 therewithin. The combination of the multi-sided housing 56 and the cavity 62 form a second connection interface 64. In operation, the cavity 62 is configured to receive the horizontally oriented cylinder forming the first connection interface 50. While the embodiments of the trolley hitch 36 and the mating cart hitch 38 shown in FIG. 4 have the first connection interface 50 as part of the trolley hitch 36 and the second connection interface 64 as part of the mating cart hitch 38, it should be appreciated that in other embodiments, the first connection interface can be part of the cart hitch 38 and the second connection interface 64 can be part of the trolley hitch 36.

Referring again to FIG. 4, the second connection interface 64 has a longitudinal axis E-E. In the illustrated embodiment, the longitudinal axis E-E of the second connection interface 64 is substantially perpendicular to a longitudinal axis F-F of the cart hitch 38. Without being held to the theory, it is believed the perpendicular orientation of the longitudinal axes E-E and F-F facilitates the effectiveness of the semi-rigid connection between the trolley hitch 36 and the cart hitch 38. However, in other embodiments, the second connection interface 64 and the cart hitch 38 can have other relative orientations, sufficient to form a semi-rigid connection therebetween.

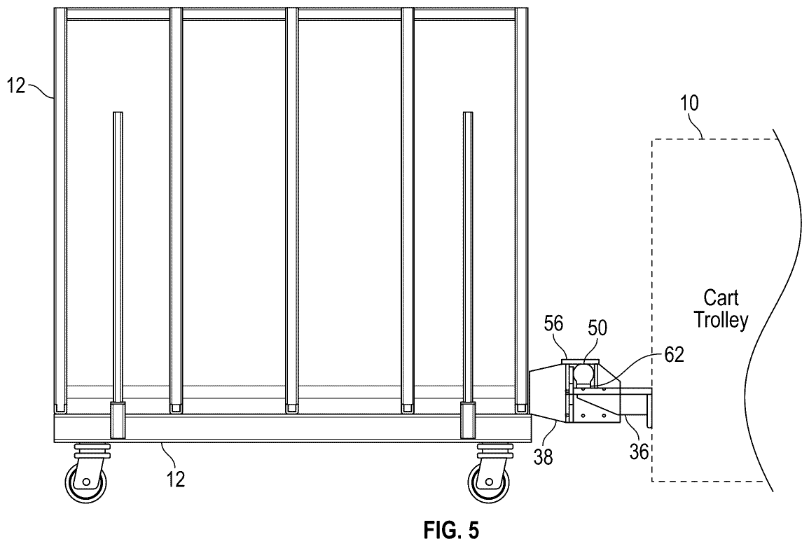

Referring now to FIG. 5 and as noted above, in operation, the cavity 62 formed by the multi-sided housing 56 is configured to receive the horizontally oriented cylinder forming the first connection interface 50. In this manner, the material cart 12 is coupled to the cart trolley 10. In operation, the first connection interface 50 is retained within the cavity 62 by the opposing cart hitch side plates (not shown for purposes of clarity).

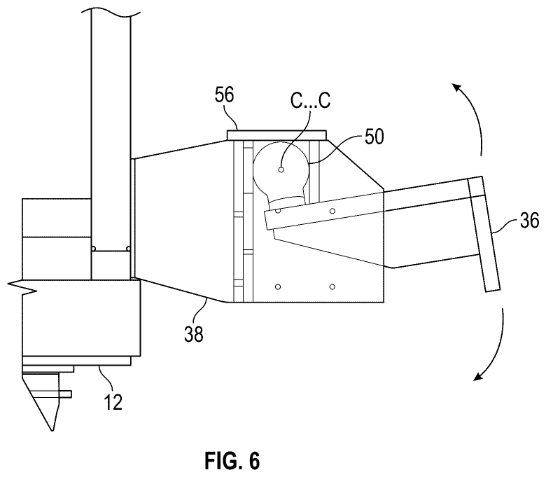

Referring now to FIG. 6, the multi-sided housing 56 has a size and shape sufficient to receive the horizontally oriented cylinder forming the first connection interface 50 therein a manner such that in an installed arrangement, the first connection interface 50 can rotate about a longitudinal axis C-C of the first connection interface 50 while being axially constrained by the opposing cart hitch side plates (not shown for purposes of clarity). It should be appreciated that once the first connection interface 50 of the trolley hitch 36 is inserted into the multi-sided housing 56 of the mating cart hitch 38, the trolley hitch 36 and the mating cart hitch 38 are connected together in a semi-rigid connection. The term semi-rigid connection, as used herein, is defined to mean a side-to-side movement of the material cart 38 relative to the cart trolley 36 is substantially prevented, however limited vertical rotation of the material cart 38 relative to the cart trolley 36, or of the cart trolley 36 to the material cart 38, is possible. The semi-rigid connection prevents side-to-side movement of the trolley hitch 36 relative to the cart hitch 38 and side-to-side movement of the cart hitch 38 relative to the trolley hitch 36, thereby providing an operator with unexpectedly precise handling of the combined cart trolley and the material cart, when uneven and/or sloped ground is encountered.

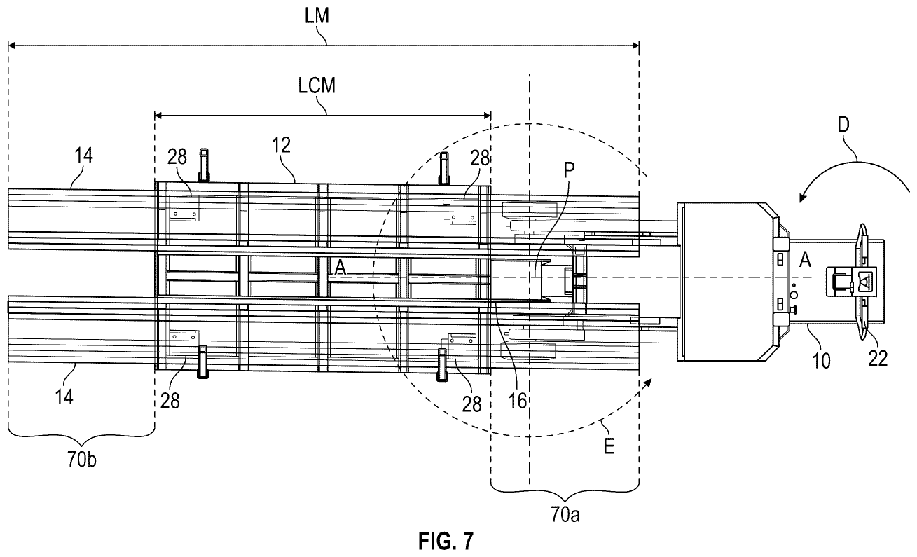

Referring now to FIG. 7, the cart trolley 10, the material cart 12, the materials 14 and the towing hitch system 16 are shown in a connected arrangement. In the connected arrangement, the towing hitch system 16 is configured to maintain a semi-rigid connection between the cart trolley 10 and the material cart 12. In the illustrated embodiment, the materials 14 has a length LM that is longer than a length LMC of the material cart 12, thereby resulting in portions 70a of the materials 14 extending in a direction toward the cart trolley 10 and past the towing hitch system 16 and other portions 70b extending in a direction away from the cart trolley 10 and beyond a back end of the material cart 12. In operation, the portions 70a of the materials 14 can operate to limit the turning radius of cart trolley 10 and material cart 12 using conventional towing hitch systems.

Referring again to FIG. 7, the towing hitch system 16 maintains a semi-rigid connection between the cart trolley 10 and the material cart 12, thereby substantially preventing front-to-back and side-to-side movement of the trolley hitch 36 relative to the cart hitch 38 and further preventing horizontal rotation of the cart hitch 38 relative to the trolley hitch 36, while facilitating limited vertical rotation of the cart hitch 38 relative to the trolley hitch 36. In operation, rotation of the steering mechanism 22 in a counterclockwise direction, as shown schematically by direction arrow D, results in rotation of the semi-rigidly connected cart trolley 10 and the materials cart 12 about a common pivot point P, as schematically depicted by direction arrow E, as the material cart 12 rolls on the plurality of omni-directional casters 28. The common pivot point P is formed at the intersection of the first and second connection interfaces 50, 64.

Referring again to FIG. 7, advantageously, the common pivot point P is positioned along a first axis A-A formed between the omni-directional casters 28 of the cart trolley 10. During the turning motion of the combined cart trolley 10 and material cart 12, the inward rear caster of the material cart 12 moves very little and the outward rear wheel moves much more relative to the inward rear wheel, thereby providing an operator with unexpectedly precise handling of the semi-rigidly connected and combined cart trolley 10 and the material cart 12, when long and/or heavy loads are carried by the material cart 12.

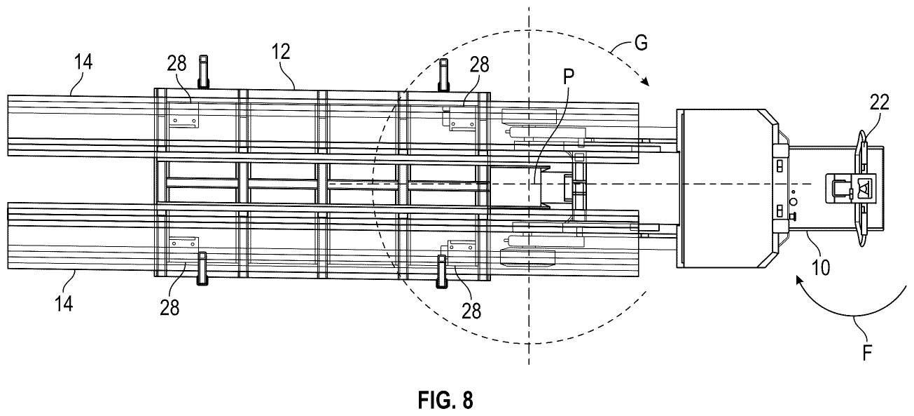

Referring now to FIG. 8, in operation, rotation of the steering mechanism 22 in a clockwise direction, as shown schematically by direction arrow F, results in rotation of the semi-rigidly connected and combined cart trolley 10 and the materials cart 12 about the common pivot point P, as schematically depicted by direction arrow G, as the material cart 12 rolls on the plurality of omni-directional casters 28. As discussed above, during the turning motion of the semi-rigidly connected and combined cart trolley 10 and material cart 12, the inward rear wheel of the material cart 12 moves very little and the outward rear wheel moves much more relative to the inward rear wheel. Accordingly, an operator is provided with unexpectedly precise handling of the semi-rigidly connected and combined cart trolley 10 and the material cart 12, when long and/or heavy loads are carried by the materials cart 12 regardless of the direction of the turn of the combined cart trolley 10 and materials cart 12.

The towing hitch system 16 provides many benefits, although all benefits may not be available in all embodiments. First, in certain embodiments, the semi-rigid connection formed by the towing hitch system results in substantially preventing relative front-to-back movement and side-to-side movement of the cart trolly 10 and the material cart 12. Second, since the towing hitch system results in a semi-rigid connection between the cart trolly 10 and the material cart 12, and since horizontal rotational movement of the cart trolley 10 results in horizontal rotational movement of the material cart about a point P, an operator is provided with unexpectedly precise handling of the rigidly connected and combined cart trolley 10 and the material cart 12, when long and/or heavy loads are carried by the materials cart 12 regardless of the direction of the turn of the semi-rigidly connected and combined cart trolley 10 and materials cart 12. Third, in certain embodiments, the semi-rigid connection between the cart trolly 10 and the material cart 12 substantially prevents a fold forming between the cart trolley 10 and the material cart 12 (commonly known as a “jack-knife” orientation). Fourth, the semi-rigid connection formed by the towing hitch system 16 results in substantially preventing side-to-side movement of the cart trolly 10 and the material cart 12, while facilitating rotation of the trolley hitch 136 about the cart hitch 138. Fifth, unexpected precise handling of the combined cart trolley 10 and the material cart 12 is accomplished regardless of the direction of the turn of the cart trolley 10. Sixth, the hitch system 16 is unaffected by material loads that are longer than a length of the material cart 12. Seventh, the hitch system 16 is unaffected by material loads that extend beyond a front edge of the material cart and may be in close proximity to the cart trolley 10. Eighth, the hitch system 16 is unaffected by heavy material loads that may cause problems during rotation of the material cart 12. Finally, the hitch system 16 provides infinite rotational freedom about a point P, thereby providing precise handling of the combined cart trolley 10 and the material cart 12.

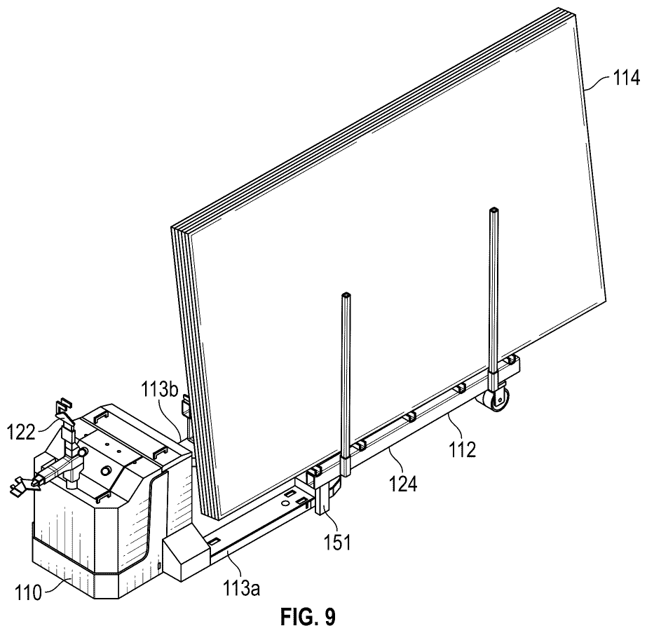

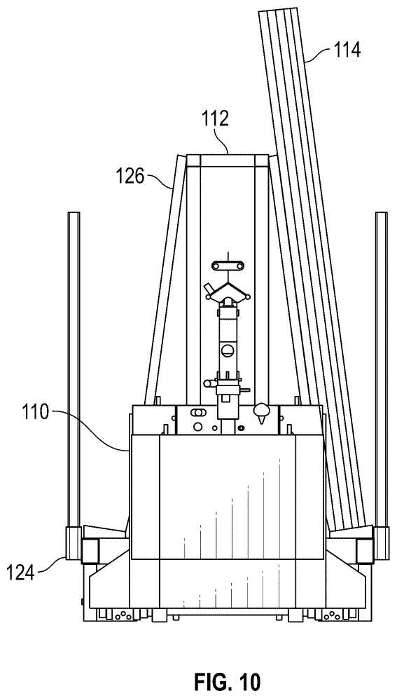

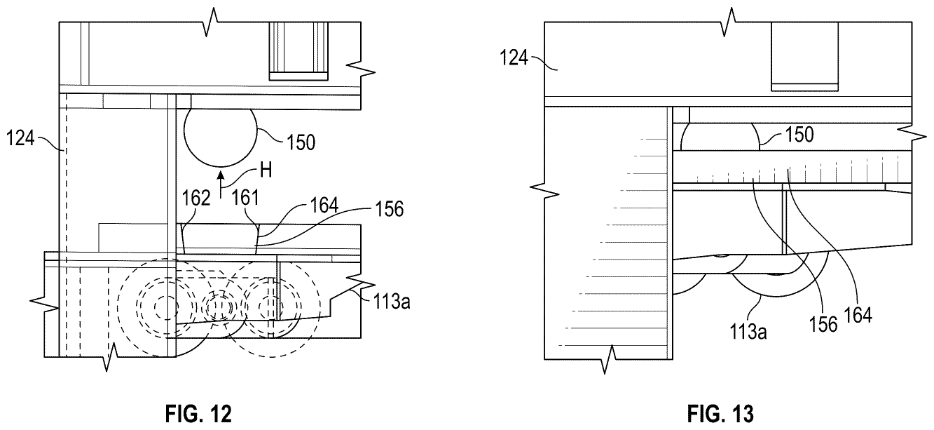

While the description above and FIGS. 1-8 describe a cart trolley 10 equipped with the towing hitch system 16, it should be appreciated that in other embodiments, other cart trolleys can be equipped with towing hitch systems having different configurations. Referring now to FIGS. 9-13, a second non-limiting example of a cart trolley 110 equipped with towing hitch system 116 is illustrated.

Referring first to FIGS. 9-11, a cart trolley 110 is shown coupled to a material cart 112. The material cart 112 is loaded with materials 114. In the illustrated embodiment, the materials 114 are the same as, or similar to, the materials 14 described above and shown in FIG. 1. However, in other embodiments, the materials 114 can be different from the materials 14.

Referring again to FIGS. 9-11, the cart trolley 110 is configured for self-propelled movement and is further configured to move the material cart 122 and the materials 114 contained in/on the material cart 112 as the cart trolley 110 moves. In the illustrated embodiment, the cart trolley 110 is the same as, or similar to, the cart trolley 10 described above and illustrated in FIG. 1 with the exception that the cart trolley 110 includes a plurality of ground-engaging forks 113a, 113b. Each of the ground-engaging forks 113a, 113b extend from the cart trolley 110 in the same direction and have a parallel orientation. It should be appreciated that in other embodiments, the cart trolley 110 can be different from the cart trolley 10. The ground-engaging forks 113a, 113b will be discussed in more detail below.

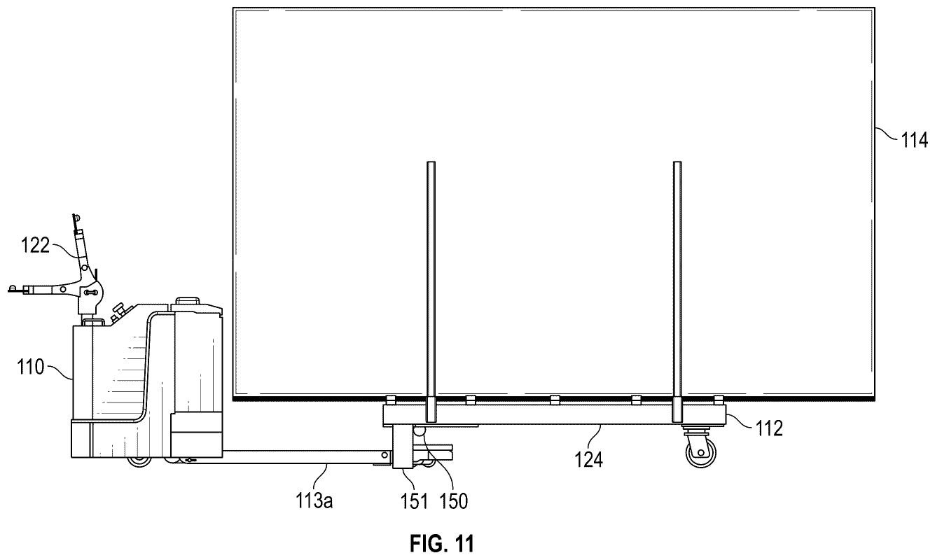

Referring now to FIGS. 9 and 11, the cart trolley 110 includes a steering mechanism 122. In the illustrated embodiment, the steering mechanism 122 is the same as, or similar to, the steering mechanism 22 described above and illustrated in FIG. 1. It should be appreciated that in other embodiments, the steering mechanism 122 can be different from the steering mechanism 22.

Referring again to FIGS. 9-11, the materials cart 112 includes a base framework 124 configured to support an upper framework 126. In the illustrated embodiment, the upper framework 126 is the same as, or similar to, the upper framework 26 described above and illustrated in FIG. 1. It should be appreciated that in other embodiments, the upper framework 126 can be different from the upper framework 26.

Referring again to the embodiment shown in FIGS. 9-11, the basic framework 124 is the same as, or similar to, the basic framework 24 described above and illustrated in FIG. 1 with two notable exceptions. First, the basic framework 124 includes a plurality of spaced apart first connection interfaces 150 positioned at one end. Second, the basic framework 124 includes a plurality of spaced apart stand members 151 positioned proximate the plurality of first connection interfaces 150 It should be appreciated that in other embodiments, the basic framework 124 can be different from the basic framework 24.

Referring now to FIGS. 11-13, each of the first connection interfaces 150 extends in a downward direction from the basic framework 124 and has the form of a horizontally oriented cylinder. In the illustrated embodiment, the horizontally oriented cylinder is the same as, or similar to, the horizontally oriented cylinder described above and illustrated in FIG. 4. It should be appreciated that in other embodiments, the horizontally oriented cylinder can be different from that shown in FIG. 4.

Referring again to FIGS. 11-13, each of the ground-engaging forks 113a, 113b includes a second connection interface 164. Each of the second connection interfaces are formed from a multi-sided housing 156. In the illustrated embodiment, each of the multi-sided housings 156 are the same as, or similar to, the multi-sided housing 56 described above and illustrated in FIG. 4. It should be appreciated that in other embodiments, each of the multi-sided housings 156 can be different from the multi-sided housing 56 shown in FIG. 4. Each of the multi-sided housings 156 form an opening 161 and a cavity 162 therewithin.

Referring again to FIGS. 11-13, operation of the towing hitch system 116 will now be described. In a first operation step, the cart trolley 110 is positioned such that each of the plurality of ground engaging forks 113a-113b is positioned under the material cart 112, with each of the second connection interfaces 164 proximate an associated first connection interface 150. In a next step, each of the ground-engaging forks 113a, 113b is moved vertically upward, as schematically illustrated by direction arrow H. Movement of each of the ground-engaging forks 113a, 113b in a vertically upward direction continues until each of the first connection interfaces 150 seats within an associated second connection interface 164. In this manner, the material cart 112 is coupled to the cart trolley 110 with a semi-rigid connection, as described above and movement of the combined cart trolley 110 and material cart 112 is enabled. During movement of the combined cart trolley 110 and material cart 112, the plurality of ground-engaging forks 113a, 133b are maintained in the raised orientation, thereby maintaining the coupling action and the semi-rigid connection of the first and second connection interfaces 150, 164.

Referring again to FIGS. 11-13, it should be appreciated that the towing hitch system 116 provides all of the benefits described above for the towing hitch system 16. It should also be appreciated that the towing hitch system 116 forms a similar common pivot point P as described above and shown in FIGS. 7 and 8, thereby providing an operator with the same unexpectedly precise handling of the semi-rigidly connected and combined cart trolley 110 and the material cart 112, when long and/or heavy loads are carried by the material cart 112.

While the embodiments of the trolley hitch 136 and the mating cart hitch 138 shown in FIGS. 11-13 have the first connection interface 150 as part of the cart hitch 138 and the second connection interface 164 as part of the trolley hitch 136, it should be appreciated that in other embodiments, the first connection interface 150 can be part of the trolley hitch 136 and the second connection interface 164 can be part of the cart hitch 138.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A towing hitch system configured to connect a cart trolley with a material cart, the towing hitch system comprising:
a trolley hitch connected to the cart trolley, the trolley hitch having a first connection interface;
a cart hitch connected to the material cart, the cart hitch having a second connection interface, the second connection interface having a cavity configured to receive a portion of the first connection interface;
wherein the combination of the first connection interface and the second connection interface is configured to form a semi-rigid connection therebetween, the semi-rigid connection configured to prevent front-to-back movement and side-to-side movement of the material cart relative to the cart trolley, the semi-rigid connection further configured to limit vertical rotation of the material cart relative to the cart trolley.

2. The towing hitch system of claim 1, wherein the cart hitch includes a spacing member positioned between the first connection interface and a trolley hitch base.

3. The towing hitch system of claim 1, wherein the first connection interface has the form of a horizontally oriented cylinder.

4. The towing hitch system of claim 1, wherein the first connection interface has a longitudinal axis that is perpendicular with a longitudinal axis of the trolley hitch.

5. The towing hitch system of claim 1, wherein the second connection interface is formed by opposing end plates, opposing side members and a top member.

6. The towing hitch system of claim 5, wherein the opposing end plates, opposing side members and the top member cooperate to form an opening.

7. The towing hitch system of claim 1, wherein the cavity is located between the opposing end plates, the opposing side members, and the top member.

8. The towing hitch system of claim 1, wherein the second connection interface has a longitudinal axis that is perpendicular with a longitudinal axis of the cart hitch.

9. The towing hitch system of claim 1, wherein the semi-rigid connection forms a common pivot point of the first and second connection interfaces, the common pivot point being positioned along an axis formed between omni-directional casters of the cart trolley, wherein a leftward turn of the cart trolley results in little movement of an inward rear caster of the material cart and much more movement of an outward rear wheel of the material cart.

10. The towing hitch system of claim 1, wherein the semi-rigid connection forms a common pivot point of the first and second connection interfaces, the common pivot point being positioned along an axis formed between omni-directional casters of the cart trolley, wherein a rightward turn of the cart trolley results in little movement of an inward rear caster of the material cart and much more movement of an outward rear wheel of the material cart.

11. A cart trolley in combination with and connected to a material cart, the combination of the trolley cart and the material cart comprising:
a trolley hitch connected to the cart trolley, the trolley hitch having a first connection interface;
a cart hitch connected to the material cart, the cart hitch having a second connection interface, the second connection interface having a cavity configured to receive a portion of the first connection interface;
wherein the combination of the first connection interface and the second connection interface is configured to form a semi-rigid connection therebetween, the semi-rigid connection configured to prevent front-to-back movement and side-to-side movement of the material cart relative to the cart trolley, the semi-rigid connection further configured to limit vertical rotation of the material cart relative to the cart trolley.

12. The combination of the trolley cart and the material cart of claim 11, wherein the cart hitch includes a spacing member positioned between the first connection interface and a trolley hitch base.

13. The combination of the trolley cart and the material cart of claim 11, wherein the first connection interface has the form of a horizontally oriented cylinder.

14. The combination of the trolley cart and the material cart of claim 11, wherein the first connection interface has a longitudinal axis that is perpendicular with a longitudinal axis of the trolley hitch.

15. The combination of the trolley cart and the material cart of claim 11, wherein the second connection interface is formed by opposing end plates, opposing side members and a top member.

16. The combination of the trolley cart and the material cart of claim 15, wherein the opposing end plates, opposing side members and the top member cooperate to form an opening.

17. The combination of the trolley cart and the material cart of claim 11, wherein the cavity is located between the opposing end plates, the opposing side members, and the top member.

18. The combination of the trolley cart and the material cart of claim 11, wherein the second connection interface has a longitudinal axis that is perpendicular with a longitudinal axis of the cart hitch.

19. The combination of the trolley cart and the material cart of claim 11, wherein the semi-rigid connection forms a common pivot point of the first and second connection interfaces, the common pivot point being positioned along an axis formed between omni-directional casters of the cart trolley, wherein a leftward turn of the cart trolley results in little movement of an inward rear caster of the material cart and much more movement of an outward rear wheel of the material cart.

20. The combination of the trolley cart and the material cart of claim 11, wherein the semi-rigid connection forms a common pivot point of the first and second connection interfaces, the common pivot point being positioned along an axis formed between omni-directional casters of the cart trolley, wherein a rightward turn of the cart trolley results in little movement of an inward rear caster of the material cart and much more movement of an outward rear wheel of the material cart.
